(19) United States
(12) Patent Application Publication
(10) Pub. No.: US 2006/0213772 A1
(43) Pub. Date: Sep. 28, 2006

(54) Sensing element and method of making

(76) Inventors: Kailash C. Jain, Troy, MI (US); Carlos A. Valdes, Flint, MI (US); Da Yu Wang, Troy, MI (US); David P. Wallace, Flint, MI (US); Paul C. Kikuchi, Fenton, MI (US); Raymond L. Bloink, Swartz Creek, MI (US); Walter T. Symons, Grand Blanc, MI (US)

Correspondence Address: Jimmy L. Funke;Delphi Technologies, Inc., M/C 480-410-202, P.O. Box 5052, Troy, MI, 48007, US

(21) Appl. No.: 11/086,225

(22) Filed: Mar. 22, 2005

(51) Int. Cl. G01N 27/26

(52) U.S. Cl. 204/431

(57) ABSTRACT

A gas sensing element and method of making are provided. The gas sensing element can comprise calcined inorganic oxides that sequester contaminants in an exhaust stream. The calcined inorganic oxides provide sensors with improved performance, thereby eliminating post-sinter chemical and/or electrical conditioning.

### TECHNICAL FIELD

The present disclosure is related to a sensing element that is responsive to the presence of a gas and a method of making the same and, more particularly, to an oxygen-sensing element that is responsive to the presence of oxygen.

### BACKGROUND

Sensors, in particular gas sensors, have been utilized for many years in several industries (e.g., flues in factories, in furnaces and in other enclosures; in exhaust streams such as flues, exhaust conduits, and the like; and in other areas). For example, the automotive industry has used exhaust gas sensors in automotive vehicles to sense the composition of exhaust gases, namely, oxygen. A sensor may be used to determine the exhaust gas content for alteration and optimization of the air to fuel ratio for combustion.

One type of sensor employs an ionically conductive solid electrolyte between porous electrodes. For oxygen detection, solid electrolyte sensors are used to measure oxygen activity differences between an unknown gas sample and a known gas sample. In the application of a sensor for automotive exhaust, the unknown gas is exhaust and the known gas, i.e., reference gas, is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (EMF) is developed between the electrodes according to the Nernst equation.

According to the Nernst principle, chemical energy is converted into electromotive force. Thus, a gas sensor based upon this principle typically consists of an ionically conductive solid electrolyte material, a porous electrode with a porous protective overcoat exposed to exhaust gases (“sensing electrode”), and a porous electrode exposed to the partial pressure of a known gas (“reference electrode”). Sensors used for automotive applications typically employ a yttria stabilized zirconia based electrochemical galvanic cell with porous platinum electrodes, operating in potentiometric mode, to detect the relative amounts of a particular gas, such as oxygen for example, that is present in an automobile engine's exhaust. Also, a typical sensor has a ceramic heater attached to help maintain the sensor's ionic conductivity at low exhaust temperatures. When opposite surfaces of the galvanic cell are exposed to different oxygen partial pressures, an electromotive force is developed between the electrodes on the opposite surfaces of the zirconia wall, according to the Nernst equation:

$$E ( \frac{- RT}{4 F} ) ln ( \frac{{P}_{{O}_{2}}^{ref}}{{P}_{{O}_{2}}} )$$

where:
E=electromotive force
R=universal gas constant
F=Faraday constant
T=absolute temperature of the gas
P_{O}_{₂}^{ref}=oxygen partial pressure of the reference gas
P_{O}_{₂}=oxygen partial pressure of the exhaust gas

Due to the large difference in oxygen partial pressure between fuel rich and fuel lean exhaust conditions, the electromotive force (EMF) changes sharply at the stoichiometric point, giving rise to the characteristic switching behavior of these sensors. Consequently, these potentiometric oxygen sensors indicate qualitatively whether the engine is operating in fuel rich or fuel lean conditions, without quantifying the actual air to fuel ratio of the exhaust mixture.

In addition to oxygen, the exhaust gas contains many components including carbon monoxide, carbon dioxide, hydrogen, water, nitrogen oxides, nitrogen, and a variety of hydrocarbons and hydrocarbon derivatives. Because the exhaust gas is a non-equilibrium mixture containing products of incomplete combustion, the oxygen partial pressure is not an equilibrium pressure. Because the oxygen partial pressure is not at equilibrium, sensors do not operate at stoichiometric air to fuel ratios per the Nernst equation. In addition, the use of zirconia-based electrolyte materials contributes to non-ideal sensor behavior.

To provide a means of monitoring the cell potential and to circumvent at least some of the difficulties associated with non-equilibrium conditions, catalytic electrodes are used to both catalyze the oxidation reactions and to equilibrate the local oxygen concentrations. Ideal sensors produce a sharp EMF or voltage step at a stoichiometric air to fuel ratio per the Nernst equation. Manufactured sensors, however, exhibit non-ideal behaviors, for example, a broadened voltage transition that occurs over a range of air to fuel ratios near the stoichiometric ratio. In addition, the sensor EMF may depend upon mass transport processes, adsorption, desorption and chemical reactions that occur at the electrodes. There is some evidence that broadened voltage transitions and non-ideal behavior are due to a loss in catalytic activity of the electrodes. Below about 600° C., the internal electrochemical factors of the sensor such as electrode polarization and electrode impedence also contribute to non-ideal behavior. Many commercial sensors cease to function at about 400° C. In order to improve sensor performance characteristics, electrolytic and chemical conditioning techniques have been utilized, which add to the cost and time associated with manufacturing.

Accordingly, a need exists in the sensor manufacturing art for sensors with improved performance, as well as a need for reproducible and less expensive methods for producing such sensors.

### SUMMARY

Disclosed herein in one embodiment is a sensing element comprising an electrochemical cell. The sensing element comprises a calcined inorganic oxide selected from an alkali metal oxide; a trivalent metal oxide; a multivalent metal oxide; and combinations comprising at least one of the foregoing.

Another embodiment is directed to a method for forming a sensing element comprising forming a calcined inorganic oxide precursor, applying the precursor to the sensing element, and heating the sensing element. The inorganic oxide can be selected from the group consisting of an alkali metal oxide; a trivalent metal oxide; a multivalent metal oxide; and combinations comprising at least one of the foregoing.

Another embodiment is directed to a sensing element precursor comprising an inorganic oxide selected from the group consisting of an alkali metal oxide; a trivalent metal oxide; a multivalent metal oxide; and combinations comprising at least one of the foregoing. The inorganic oxide can be calcined in some embodiments.

The above described and other features are exemplified by the following figures and detailed description.

### DRAWINGS

Refer now to the figures, which are exemplary embodiments, and wherein like elements are numbered alike.

FIG. 1 is an exploded perspective view of a sensing element according to the present disclosure.

FIG. 2(a) is a graphical representation of the switching performance of an unheated oxygen sensor control.

FIG. 2(b) is a graphical representation of the switching performance of the heated oxygen sensor of FIG. 2(a).

FIG. 3 is a graphical representation of the switching performance of an exemplary oxygen sensor according to the present disclosure, when heated.

FIG. 4 is a graphical representation of the switching performance of another exemplary oxygen sensor according to the present disclosure, when heated.

FIG. 5(a) is a graphical representation of the switching performance of another exemplary oxygen sensor according to the present disclosure, when unheated.

FIG. 5(b) is a graphical representation of the switching performance of the oxygen sensor of FIG. 5(a), when heated.

FIG. 6(a) is a graphical representation of the switching performance of another exemplary oxygen sensor according to the present disclosure, when unheated.

FIG. 6(b) is a graphical representation of the switching performance of the oxygen sensor of FIG. 6(a), when heated.

FIG. 7 is a graphical representation of the switching performance of another exemplary oxygen sensor according to the present disclosure, when heated.

FIG. 8 is a graphical representation comparing the switching performance of another exemplary oxygen sensor according to the present disclosure, when heated, to the switching performance of the sensors shown in FIGS. 2(b) and 4.

FIG. 9 is a graphical representation of the impedance spectra of the same sensors represented in FIG. 8.

### DETAILED DESCRIPTION

At the outset of the detailed description, it should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. The modifier “about” used in connection with a quantity is inclusive of the stated value and has the meaning dictated by the context (e.g., includes the degree of error associated with measurement of the particular quantity). Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). Finally, unless defined otherwise, technical and scientific terms used herein have the same meaning as is commonly understood by one of skill in the art to which this invention belongs.

Disclosed herein is a sensing element that is responsive to the presence of a gas, and methods of making the same. The sensing element can comprise certain calcined inorganic oxides that sequester contaminants contained in a gaseous stream to which the senor element can be exposed. Sequestration of the contaminants can be accomplished by agglomeration, precipitation in grain boundaries, and/or devitrification of glassy layers, and/or the like. As a result of the sequestration of impurities, improved catalytic activity can be obtained. As a result of the improved catalytic activity, post-sintering electrical and/or chemical conditioning can be eliminated.

Also disclosed herein are methods for forming the sensing elements. The methods can comprise forming a calcined inorganic oxide precursor and applying the precursor to various materials used in fabricating the sensing element and/or its components such as, for example, green tapes, protection layers, and the like. Another method for forming the sensing elements can comprise forming various components of the sensing element from the precursor such as, for example, the electrolyte, the electrodes, the air channels, the green tapes, the vias, the contacts, and the like. Another method for forming the sensing elements can comprise exposing the green sensing element and/or green components of the sensing element to fumes of the inorganic oxides during calcination.

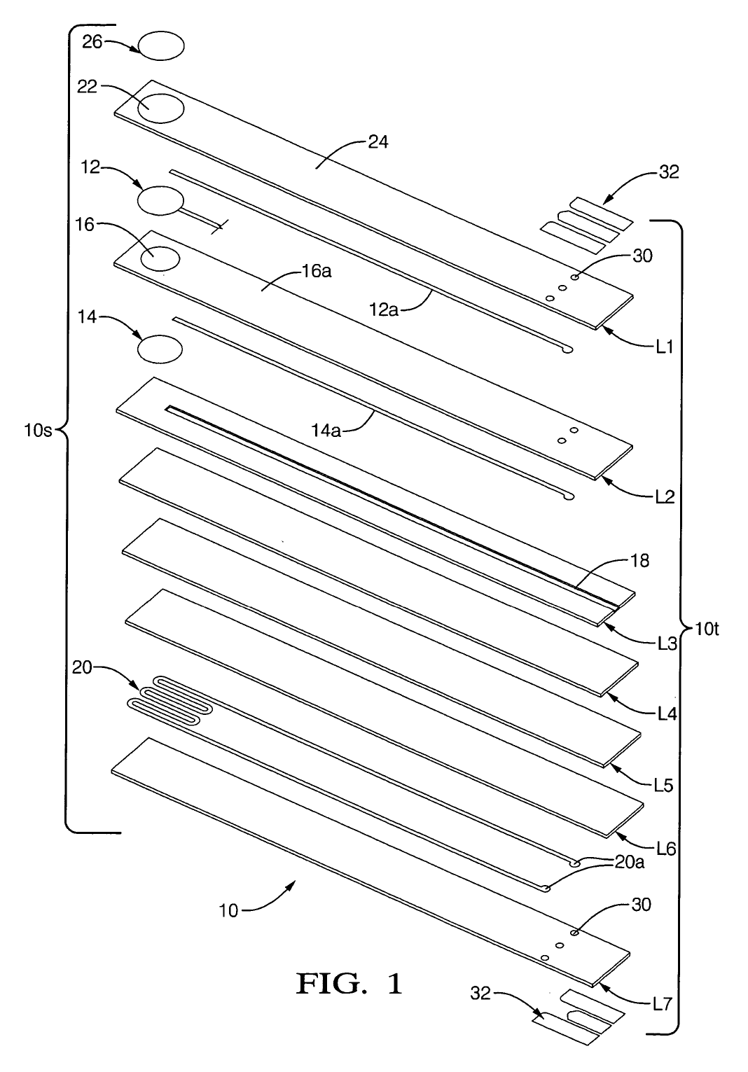

An exemplary planar oxygen-sensing element 10 is shown in FIG. 1. Although described herein in connection with an oxygen-sensing element, it is to be understood that the disclosure applies to other sensing elements such as nitrogen oxide, hydrogen, hydrocarbon, and the like. In addition, although described in connection with a planar sensing element, it is to be understood that other types of sensing elements can comprise the inorganic oxides described herein such as, for example, wide-range, switch-type, and the like.

As shown in FIG. 1, sensing element 10 can comprise a sensing end 10s and a terminal end 10t. The sensing element 10 can comprise a sensing (i.e., first, exhaust gas or outer) electrode 12, a reference gas (i.e., second or inner) electrode 14, and an electrolyte portion 16. The electrolyte portion 16 can be disposed at the sensing end 10s with the electrodes 12,14 disposed on opposite sides of, and in ionic contact with the electrolyte portion 16, thereby creating an electrochemical cell (12/16/14).

As shown, sensing element 10 comprises support layers L1-L7, but it should be understood that the number of layers can vary depending on a variety of factors. The layers provide structural integrity (e.g., protect various portions of the gas sensor from abrasion and/or vibration, and the like, and provide physical strength to the sensor), and physically separate and electrically isolate various components. Depending on the arrangement, the support layers can comprise a dielectric material and/or an electrolytic material, and the like. An example of a dielectric material is alumina (i.e. aluminum oxide (Al₂O₃). An example of an electrolyte material is zirconia. Each of the support layers can comprise a thickness of about 500 micrometers or so, depending upon the number of layers employed, more particularly about 50 micrometers to about 200 micrometers.

Optionally, a reference gas channel 18 can be disposed on the side of the reference electrode 14 opposite electrolyte portion 16. The reference gas channel 18 can be disposed in fluid communication with the reference electrode 14 and optionally with the ambient atmosphere and/or the exhaust gas.

Also optionally, a heater 20 can be disposed on a side of the reference gas channel 18 opposite the reference electrode 14, for maintaining sensing element 10 at a desired operating temperature. The optional heater 20 can be any heater capable of maintaining the sensor end at a sufficient temperature to facilitate the various electrochemical reactions therein. The heater 20 can be, for example, platinum, aluminum, palladium, and the like, as well as oxides, mixtures, and alloys comprising at least one of the foregoing metals. The heater 20 can be disposed on one of the insulating layers by various methods such as, for example, screen-printing. The thickness of the heater 20 can be about 5 micrometers to about 50 micrometers.

Optionally, a protective insulating layer L1 can be disposed adjacent to the sensing electrode 12 opposite the electrolyte portion 16. The optional protective insulating layer L1 can be any material that enables fluid communication between the sensing electrode 12 and the gas to be sensed. For example, the protective insulating layer L1 can comprise a porous ceramic material formed from a precursor comprising a ceramic (such as a spinel, alumina, zirconia, and/or the like) carbon black, and an organic binder; the carbon black can function as a fugitive material to provide pore formation in the fired layer. The protective layer L1 may optionally comprise an aperture (not illustrated) disposed adjacent to the sensing electrode 12, and a solid portion 24. A porous portion 22 can be disposed in the aperture, which can comprise a porous spinel, alumina, zirconia, and/or the like. The porous portion 22 can be formed, for example, from a precursor comprising about 70 to about 80 wt. % of one or more of the foregoing ceramic materials, about 5 to about 10 wt. % carbon black, and about 15 wt. % to about 20 wt. % of an organic binder, which can be applied using various methods including thick film methods and the like, followed by sintering. The carbon black can function as a fugitive material to provide pore formation in the sintered material.

Also optionally, a protective coating 26 can be disposed over at least the porous portion 22 of layer L1, adjacent to the sensing electrode 12. Possible materials for the protective coating 26 can comprise spinel, alumina, and/or stabilized alumina, and the like.

If desired, one or more support layers can be disposed on a side of the sensing electrode 12 opposite the electrolyte 16; between the reference gas channel 18 and the heater 20, and on a side of the heater 20 opposite the reference gas channel 18. As shown, insulating layer L1 is disposed on a side of the sensing electrode 12 opposite the electrolyte portion 16; insulating layers L3-L6 are disposed between the reference gas channel 18 and the heater 20; and insulating layer L7 is disposed on a side of the heater 20 opposite the reference gas channel 18.

Electrolyte portion 16 can comprise a solid electrolyte. Layer L2 can comprise a dielectric material. The electrolyte portion 16 can be supported on layer L2 in a variety of arrangements such as, for example, supported as a layer on the surface of layer L2, or as shown in an aperture disposed adjacent to the sensing end 10s. The latter arrangement eliminates the use of excess electrolyte and protective, material, and reduces the size of the sensing element by eliminating layers. Any shape can be used for the electrolyte and porous section, with the size and geometry of the various inserts, and therefore the corresponding openings, being dependent upon the desired size and geometry of the adjacent electrodes. The openings, inserts, and electrodes can comprise a substantially compatible geometry such that sufficient exhaust gas access to the electrode(s) is enabled and sufficient ionic transfer through the electrolyte is established. The electrolyte can comprise a thickness of up to about 500 micrometers, more specifically about 25 micrometers to about 500 micrometers, and more specifically about 50 micrometers to about 200 micrometers.

The electrolyte 16 can be, for example, any material that is capable of permitting the electrochemical transfer of oxygen ions while inhibiting the passage of exhaust gases, should have an ionic/total conductivity ratio of approximately unity, and should be compatible with the environment in which the gas sensor will be utilized (e.g., up to about 1,000° C.). Possible electrolyte materials can comprise any material capable of functioning as a sensor electrolyte including, but not limited to, zirconium oxide (zirconia), cerium oxide (ceria), calcium oxide, yttrium oxide (yttria), lanthanum oxide, magnesium oxide, ytterbium (III) oxide (Yb₂O₃), scandium oxide (Sc₂O₃), and the like, as well as combinations comprising one or more the foregoing. Zirconia optionally may be stabilized with calcium, barium, yttrium, magnesium, aluminum, lanthanum, cesium, gadolinium, and the like, as well as combinations comprising at least one of the foregoing materials. For example, the electrolyte can be alumina and/or yttrium stabilized zirconia.

The sensing and reference electrodes 12,14 which are exposed to the exhaust gas and a reference gas, respectively during operation, can comprise a porosity sufficient to permit diffusion to oxygen molecules therethrough. The sensing and reference electrodes 12, 14 can comprise any catalyst capable of ionizing oxygen including, but not limited to, materials such as platinum, palladium, osmium, rhodium, iridium, gold, ruthenium, zirconium, yttrium, cerium, calcium, aluminum, silicon, and the like, and oxides, mixtures, and alloys comprising at least one of the foregoing catalysts. Other additives such as zirconia may be added to impart beneficial properties such as inhibiting sintering of the catalyst to maintain porosity. The electrodes can comprise a thickness of less than or equal to about 10 micrometers, more particularly less than or equal to about 7 micrometers, and still more particularly less than or equal to about 5 micrometers. The electrodes also can comprise a thickness of greater than or equal to about 0.1 micrometer, more particularly greater than or equal to about 1 micrometer, and still more particularly greater than or equal to about 3 micrometers.

Leads 12a, 14a supply current to the electrodes 12, 14, and extend from electrodes 12,14 respectively, to the terminal end 10t of the sensing element 10 where they are in electrical communication with corresponding vias 30 and contact pads 32. Similarly, leads 20a supply current to the heater 20, and extend from the heater 20 to the terminal end 10t of the sensing element 10 where they are in electrical communication with corresponding vias 18 and contact pads 20. Leads 12a, 14a and 20a can be formed on the same layers as the electrodes and heater with which they are in electrical communication, as they are in the present exemplary embodiment. The electrode leads 12a, 14a and the vias 18 in the insulating and/or electrolyte layers can be formed separately from or simultaneously with electrodes the 12,14.

In addition to the foregoing, sensing element 10 can comprise other sensor components (not illustrated) including, but not limited to, ground plane layers(s), support layer(s), additional electrochemical cell(s), lead gettering layer(s), and the like.

As noted above, the sensing element 10 or individual components of sensing element 10, can comprise one or more calcined inorganic oxides. Possible calcined inorganic oxides include, but are not limited to, alkali metal oxides, oxides of trivalent metals, oxides of multivalent metals, and combinations comprising at least one of the foregoing.

Possible calcined inorganic oxides can be selected for their reactivity toward acidic oxides such as silicon and phosporous, such they sequester impurities that come into contact with the sensing element. The inorganic oxides, before and/or after calcination, can be capable of withstanding the processing conditions used to form the sensor e.g. a melting point greater than the maximum temperatures used in subsequent processing steps, such as greater than or equal to about 1350° C., more particularly greater than or equal to about 1550° C. In addition, the inorganic oxides can comprise a relatively-low partial pressure, which can minimize or prevent volatilization of the inorganic oxide during processing. In practice, some inorganic oxides can be combined in order to achieve a mixed oxide having some or all of the foregoing characteristics.

For example, it is possible to combine an inorganic oxide that has a melting point lower than the calcination temperature with, for example, an alkali metal oxide, such that the resulting oxide mixture can withstand higher temperatures. Examples of the foregoing include barium oxide (BaO), potassium oxide (K₂O); lead oxide (PbO); antimony trioxide (Sb₂O₃); antimony tetraoxide (Sb₂O₄); antimony pentoxide (Sb₂O₅); and yttrium oxide (Y₂O₃).

Examples of inorganic oxides that have relatively high partial pressures include, but are not limited to, antimony oxides (Sb₂O₃), (Sb₂O₄) and (Sb₂O₅) and mixed oxides comprising an antimony oxide.

Examples of inorganic oxides that have relatively high melting points (i.e. greater than about 1,350° C.) in addition to relatively low partial pressures include, but are not limited to, sodium antimonate (NaSbO₃), potassium antimonate (KSbO₃), and combinations comprising at least one of the foregoing.

One possible mixed oxide comprises an antimony oxide [(Sb₂O₃), (Sb₂O₄) and (Sb₂O₅)], an alkali metal oxide, an oxide of a trivalent or multivalent metal, and combinations comprising at least one of the foregoing.

Examples of the foregoing include, but are not limited to (KSbO₃.K₂O.BaO.Y₂O₃) and (NaSbO₃.K₂O.BaO.Y₂O₃). When the inorganic oxides comprise an alkali metal, it can be beneficial to include additional amounts of the alkali metal in order to provide an atmosphere rich in the excess metal, which can minimize the loss of the alkali metal from the oxide. For example, when the alkali metal can comprise potassium (K), an excess of potassium can provide a potassium-rich atmosphere, which minimizes the loss of potassium (K) due to volatilization at the relatively high sintering temperatures.

Another possible mixed oxide comprises antimony trioxide (Sb₂O₃), an alkali metal oxide, and an oxide of a trivalent or multivalent metal, and combinations comprising at least one of the foregoing. Examples of the foregoing include, but are not limited to (Sb₂O₃.BaO,); (Sb₂O₃.BaO.Y₂O₃); (Sb₂O₃.K₂O.BaO.Y₂O₃); and (Sb₂O₃.PbO.K₂O.BaO.Y₂O₃).

In any of the foregoing inorganic oxides, substitutions can be made as follows: potassium (K) can be substituted by certain alkali metals; barium (Ba) can be substituted by certain alkaline earth metals; and yttrium (Y) can be substituted by selected Group III transition metals and/or selected lanthanide series metals. Specifically, potassium can be substituted by lithium (Li), sodium (Na), rubineum (Rb), and/or cesium (Cs). Barium (Ba) can be substituted by magnesium (Mg), calcium (Ca), and/or strontium (Sr). Yttrium (Y) can be substituted by scandium (Sc), samarium (Sm), gadolinium (Gd) and/or ytterbium (Yb). Substitution of potassium (K) by cesium (Cs) enhances the inorganic oxide due to the larger ionic size of cesium in comparison to potassium (K), lithium (Li), sodium (Na) and/or rubineum (Rb). The larger ionic size can result in slower diffusion in the solid electrolyte.

The sensing element 10 or components of the sensing element 10 can be treated with the foregoing inorganic oxides using various methods. The inorganic oxides can be applied to the sensor and/or its components prior to calcining the green sensing element, such that the inorganic oxides are calcined simultaneously with the sensing element. Alternatively, the inorganic oxides can be calcined prior to application to or incorporation into a sensing element or its components.

Calcining the inorganic oxides can comprise forming a slurry solution by adding a selected uncalcined inorganic oxide and a ceramic material (such as zirconia and/or yttria stablized zirconia beads, and/or the like) to a suitable solvent (such as isopropyl alcohol). The slurry can then be dried and mixed using a mortar and pestle. The dried mixture can then be calcined by heating it in a platinum crucible for about 1-4 hours at about 700° C.-1,150° C., more specifically about 1-2 hours at about 800° C. The slurry can then be tumbled for about 10 hours to about 200 hours, more particularly for about 100 hours. After tumbling, the slurry can be dried, sieved, and used immediately or stored for later use.

A solution of a mixed oxide can be prepared by selecting a soluble acetate salt, carbonate salt, nitrate salt, and/or the like, corresponding to the desired inorganic oxide. The selected soluble salt and a ceramic material then can be added to a suitable solvent to form a slurry solution. For example, antimony nitrate can be dispersed in a solution of barium acetate and yttrium nitrate. The slurry can then be dried and mixed using a mortar and pestle. The dried mixture can then be calcined by heating it in a platinum crucible for about 1-4 hours at about 700° C.-1,150° C., more particularly about 12 hours at about 800° C. After calcining, the mixture can be crushed to a powder using, for example, a mortar and pestle. A slurry can then be formed by mixing the crushed powder with isopropyl alcohol and zirconia or yttria stablized zirconia beads. The slurry can then be tumbled for about 10 hours to about 200 hours, more particularly for about 100 hours. After tumbling, the slurry can be dried, sieved, and used immediately or stored for later use.

Various compositions can be formed using the foreoing calcined inorganic oxides and/or calcined inorganic oxide mixtures. For example, compositions comprising the inorganic oxides and/or calcined inorganic oxides can be formulated as electrode inks, fugitive inks, slurries, pastes, and the like. The compositions can be used to form one or more component of the sensing element such as, for example, insulating layers, electrolytic layers, porous and solid electrolytes, electrodes, leads, heaters, contact pads, interconnects between layers, air channels, protective dividers, covers, and the like, and combinations comprising at least one of the foregoing.

Electrode ink compositions can be prepared by dispersing one or more of the foregoing calcined inorganic oxides and an oxygen ionization catalyst (e.g. platinum, gold, and/or the like), and an electrolyte material in a suitable organic vehicle. The organic vehicle can be an organic solvent and/or diluent that is suitable for providing a colloidal suspension or paste of the foregoing materials. Any of the calcined inorganic oxides, catalysts, and electrolyte materials disclosed above can be used in the electrode ink composition. The calcined inorganic oxide, catalyst and electrolyte material can comprise a particle diameter of about 0.2 micrometers to about 5 micrometers. The electrode ink composition can be formulated to comprise about 55 wt. % to about 70 wt. % solids, more particularly about 65 wt. % solids, based on the total weight of the ink composition.

The electrode ink compositions can comprise about 0.5 wt. % to about 5 wt. %, more particularly about 3 wt. % of the calcined inorganic oxide; about 58 to about 65 wt. %, more particularly about 60 to about 63 wt. %, and more particularly still about 60 wt. % of the catalyst; and about 3.0 to about 5.5 wt. %, more particularly about 3.5 wt. %, of the electrolyte material; with the remainder comprising the organic vehicle; based on the total weight of the electrode ink composition.

Fugitive ink compositions can be prepared by dispersing one or more of the foregoing calcined inorganic oxides and a fugitive material, in a suitable organic vehicle. As used herein, “fugitive material” means a material that will occupy space until the electrode is fired, thereby leaving pores in the fired ink. Any of the calcined inorganic oxides, electrolyte materials, and organic vehicles described above with reference to the electrode ink can be used in the fugitive ink composition. The fugitive ink (paste) compositions can be formulated to comprise a viscosity of about 63 poiseuille (Pa·s) to about 77 Pa·s. Possible fugitive materials comprise graphite, carbon black, starch, nylon, polystyrene, latex, other soluble organics (e.g., sugars and the like) and the like, as well as compositions comprising one or more of the foregoing. The fugitive material can be added to the fugitive ink compositions in particulate form, with the particles comprising a diameter of about 0.02 micrometers to about 0.2 micrometers. The fugitive ink compositions can comprise about 0.5 wt. % to about 8 wt. %; more particularly 2 wt. % to about 6 wt. %; and more particularly still about 4 wt. % of one or more calcined inorganic oxide; and about 40 wt. % to about 50 wt. %; more particularly about 32 wt. % to about 38 wt. %; and more partiularly still about 35 wt. % of the fugitive material; with the remainder comprising the organic vehicle; and with all weights based on the total weight of the fugitive ink compositions. The electrolyte and fugitive compositions create uniform or nearly uniform pores during sintering to maintain gas permeability and increase catalytically active surface area. The electrolyte and fugitive materials additionally provide catalytic regions at the electrode-sensor electrolyte interface to extend performance of the sensor down to about 400° C. or even lower.

The thickness of the electrode and fugitive compositions disposed on the electrolyte body may be varied depending on the application method and durability requirements. The thickness of the fired electrode and fugitive inks can be controlled by dipping the electrolyte body (i.e., L2) in the ink, and then regulating the dwell time in the ink composition, and the rate at which the electrolyte body is withdrawn from the ink composition. Electrode durability increases with thickness, but at the cost of decreased sensor sensitivity. Thus, a balance between durability and sensitivity exists and the desired balance may be achieved by controlling the thickness of the metal ink during deposition.

Colloidal suspensions of the inorganic oxides also can be prepared by dispersing, for example, about 3 to 5 milligrams of one or more of the foregoing inorganic oxides and/or calcined inorganic oxides in a suitable organic vehicle. The inorganic oxide and/or calcined inorganic oxide can be suspended in any organic solvent and/or diluent that is suitable for providing a colloidal suspension of the materials. Suitable organic vehicles include any of those described above with respect to the electrode and fugitive ink formulations. The colloidal suspension can be applied, for example, by brushing the suspension onto appropriate green sheets, or onto the green sensing element prior to sintering. The colloidal suspension can then be dried actively and/or passively. The green sheets coated with the colloidal suspension of the inorganic oxides then can be calcined, as described below, or they can be processed further before calcining.

Thus, the sensing element and/or its components can be formed using one or more of the foregoing compositions, which can be used to form support layers i.e. green electrolyte sheets or green ceramic layers (“green sheets”). The compositions also can be used to form one or more of the electrodes, leads, heaters, contact pads, interconnects between layers, air channels, protective divider and cover, by disposing the inks onto the green sheets, whether or not they comprise the inorganic oxide.

Thus, using the foregoing compositions comprising the inorganic oxides and/or calcined inorganic oxides, one or more components of the sensor element can be formed using various thin and/or thick film techniques. Examples of thin film techniques include, but are not limited to, chemical vapor deposition, electron beam evaporation, sputtering, and others, as well as combinations comprising one or more of the foregoing techniques. Examples of thick film techniques include, but are not limited to, coating (including dip coating and slurry coating), die pressing, painting, printing (including ink jet printing, pad printing, screen printing, stenciling, and transfer printing), punching and placing, roll compaction, spinning, spraying (including electro-static spraying, flame spraying, plasma spraying and slurry spraying), tape casting, and others, as well as combinations comprising one or more of the foregoing. If a co-firing process is used for the formation of the sensor, screen-printing the electrodes onto appropriate tapes enhances simplicity, economy and compatibility with the co-firing process.

Formation of the sensing element can comprise forming the electrolytic cell by disposing the sensing electrode and the reference electrode on opposite sides of the electrolyte layer, optionally forming a gas reference channel on one insulating layer opposite the reference electrode, optionally forming a heater on an insulating layer opposite the gas reference channel, and optionally forming a protective insulating layer adjacent to the sensing electrode.

Optionally, a colloidal suspension of the inorganic oxides can be formed and applied to the green sensor element and/or its components. The colloidal suspension can be applied, for example, by brushing the suspension onto appropriate green sheets, or onto the green sensing element prior to sintering. The colloidal suspension can then be dried actively and/or passively. The green sheets coated with the colloidal suspension of the inorganic oxides then can be calcined, as described below, or they can be processed further before calcining.

Optionally, a green sensing element can be formed prior to calcining the green sheets. Forming a green sensing element can comprise stacking the individual green sheets in an arrangement based on the particular type of sensor being formed. Then, the stacked green sheets can be laminated with heat and under pressure to create a green sensing element.

Also optionally, a laminated stack or “tile” that contains multiple sensing elements can be formed prior to calcining the green sheets. Forming a tile can comprise stacking, aligning, and heat treating additional layers to form laminated stacks that contain the multiple sensing elements.

Again prior to calcining the green sheets, the sensing element and/or its components optionally can be treated with the foregoing inorganic oxides by exposing the green sheet, the green sensing element, and/or the tiles, to vapors or fumes of the inorganic oxides. The green sheets, green sensing elements, and/or tiles can be loaded onto a carrier (such as an alumina setter with slots for receiving and supporting the elements). One or more powdered inorganic oxides can be placed in the carrier, for example, about 50 milligrams to about 200 milligrams of the inorganic oxides, more particularly about 100 milligrams of the inorganic oxides. Then, the green sheets, greeen sensing elements and/or tiles can be disposed in the carrier such that the side of the electrode that can comprise the porous protection layer faces the powder. The green sheet, green sensing elements, and/or green tiles then can be calcined as described below.

Alternatively, the green sheets can be calcined individually.

Calcining the green sheets, green sensing element, and/or the tiles can comprise heating the same at a sufficient temperature and for a sufficient period of time to calcine both the green sheets and the inorganic oxides contained in the ink and/or slurry contained in or on the foregoing. For example, the green sheets can be calcined at about 1,475° C. to about 1,550° C., more particularly about 1,490° C. to about 1,510° C., for a period of time of up to about 3 hours, and still more particularly for a period of time of about 100 to about 140 minutes.

In addition, if the green sheets, green sensing element and/or tile are disposed in a carrier as described above, the temperatures reached during the calcining process can volatilize at least a portion of the inorganic oxides contained in the carrier. Thus, during the heating process, the volatilized inorganic oxides can be deposited onto the green sheets or tiles, and the deposited inorganic oxides can be calcined on the surface of the sensing element substantially simultaneously with the green sheet calcination. In addition, the calcined oxides can penetrate through at least a portion of the green sheets to reach, for example, the electrolyte.

All of the foregoing methods of treating the sensing elements with inorganic oxides and/or calcined inorganic oxides are separable and combinable. That is, the present disclosure includes forming a sensor using any combination of the foregoing methods of incorporating the calcined inorganic oxides into a sensor such as, for example: (1) forming compositions to use in tape castings support layers; (2) forming electrode and/or fugitive ink compositions to use in forming the electrodes, leads, heaters, contact pads, interconnects between layers, air channels, and the like; (3) forming colloidal suspensions for applying to green sheets prior to calcining; and (4) exposing green sheets to fumes of the inorganic oxides during calcining. Of course, if it is desired to selectively dispose the calcined inorganic oxides into selected components of the sensing element, it can be preferable to use the ink compositions to do so, without using the colloidal suspension or exposure to fumes thereafter.

After calcining, the sensing elements can be assembled in a suitable package for testing, or they can be disposed in a housing to form an oxygen sensor. Although the sensor can be used in various applications, including factories and the like, it is particularly useful in vehicle exhaust systems, such as, heavy-duty diesel truck applications.

Unless specified otherwise, all dimensions disclosed herein are prior to firing (i.e., in the green state).

Sensors comprising the foregoing inorganic oxides have several improved characteristics such as: (1) improved bonding of the sensor electrodes to the solid electrolyte, which provides high thermal, mechanical, and corrosion stability; (2) high positive voltage output and a low internal resistance to exhaust gas temperatures as low as 400° C., when unheated; (3) a surface and electrode morphology that exhibits improved sequestering of the contaminants from the exhaust gas; (4) long service life, fast switching response, short light-off times, and a very narrow scatter in switching measurements; (5) improved switching characteristics under load in comparison to sputtered noble metal electrodes, zirconia (partially or fully stabilized or alumina) containing composite noble metal electrodes, unsintered composite electrodes, and oxide containing electrodes; (6) electrocatalytic electrodes with low overpotential, improved tolerance to combustion residuals in an exhaust gas; and (8) performance comparable or better than sensors comprising lead. In addition, manufacturing costs and time are substantially reduced due to the elimination of post sintering electrical and/or chemical conditioning treatment.

The following non-limiting examples further illustrate the various embodiments described herein.

### WORKING EXAMPLES

Two control oxygen-sensing elements were formed using standard raw green materials. The control sensing elements were conditioned using EHF, and compared to oxygen-sensing elements formed according to the present disclosure. The sensing elements were assembled in a package to form an oxygen sensor.

The switching characteristics of the oxygen sensors were tested a gas bench, which is a sensor test apparatus that utilizes a standard simulated exhaust gas i.e. a gas that is similar in composition to an engine exhaust gas. The tests were performed: (1) with the heater power @ 0 W (i.e., the sensor was unheated when tested); (2) with the heater power @ 7.3 Watts @ 13.5 Volts (i.e., the sensor was heated when tested); (3) or both.

### Example 1

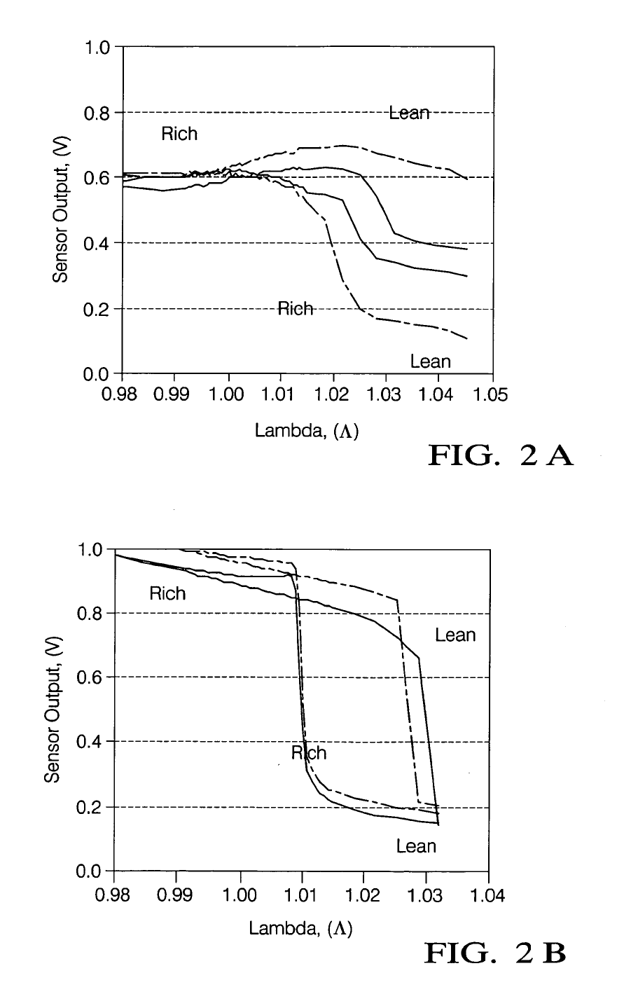

Two control oxygen sensors were formed i.e. without the calcined inorganic oxides according to the present disclosure. The sensors were conditioned with electrical aging and HF (EHF), assembled in a package, and tested. A graphical representation of the switching characteristics of the unheated control sensors is shown in FIG. 2(a), and the switching characteristics of the heated control sensors is shown in FIG. 2(b).

As shown in FIG. 2(a), the two unheated control sensors had low amplitude (0V-0.25V) due to high internal resistance and exaggerated hysteresis between L→R and R→L transitions. As shown in FIG. 2(b), when heated, the two control sensors had an output of about 0.8V. In addition, the hysteresis in L→R and R→L transitions was about 0.02λ, and the lean shift was about 0.01λ from stoichiometry (i.e. air/fuel ratio (λ=1)). In addition, the control sensors had high internal resistance, which increased the light-off times, especially below 600° C. Therefore, the control sensing elements were not considered suitable for engine control applications.

### Example 2

Three different colloidal solutions of inorganic oxides were prepared by adding the following inorganic oxides at the following concentrations to isopropyl alcohol:
(a) Solution A: 0.25 M antimony trioxide (Sb₂O₃);
(b) Solution B: 0.25M antimony trioxide (Sb₂O₃) and 0.125M barium acetate (BaC₂H₃O₂);
(c) Solution C: 0.25M antimony trioxide (Sb₂O₃), 0.125M barium acetate (BaC₂H₃O₂), and 0.25M yttrium nitrate (Y₂NO₃).

Three (3) green electrodes (Pt and ZrO₂ paste) were separately coated with about 20 milligrams of one of the colloidal solutions (A, B and C) i.e., one electrode was coated with Solution A; another with Solution B; and another with Solution C. The electrodes were then heated to about 20° C.-80° C. for about 5 minutes to about 30 minutes to dry the colloidal solution. The green electrode sheets were then laminated with other sensing element components by pressurizing and heating, to form green sensing elements. The green sensing elements were then heated to a temperature of about 1,500° C. to complete the sintering, and then assembled in a package for testing.

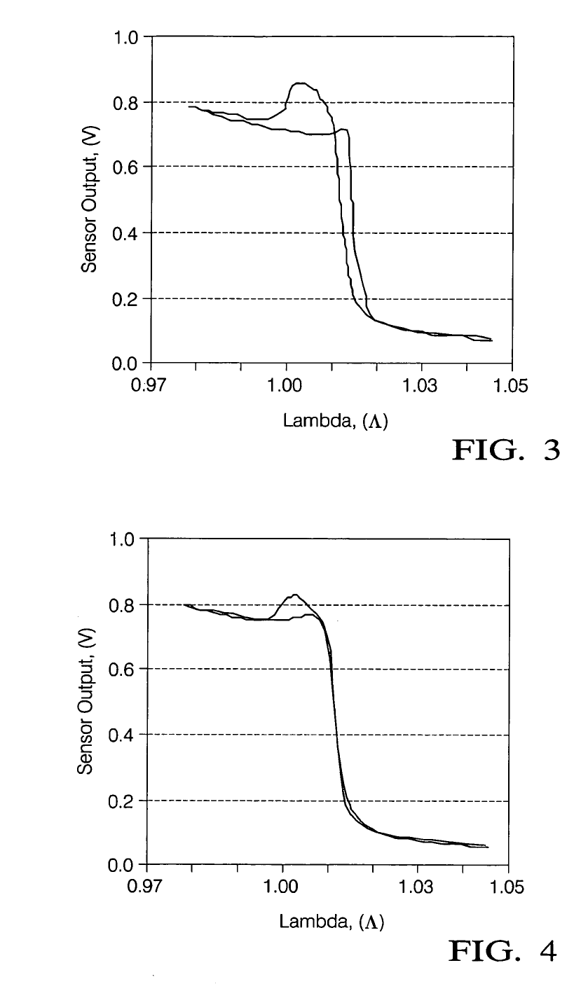

A graphical representation of the switching characteristics of the foregoing sensing elements is shown in FIGS. 3, 4, 5(a) and 5(b).

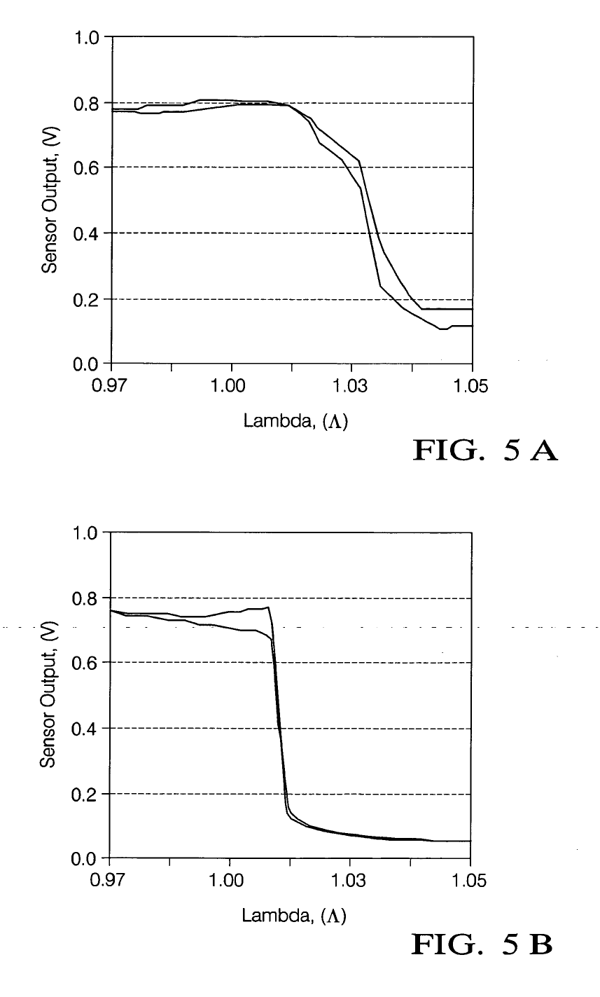

FIG. 3 represents the sensor treated with antimony trioxide (Solution A) when heated. FIG. 4 represents the sensor treated with antimony trioxide and barium acetate (Solution B) when heated. FIG. 5(a) represents the sensor treated with antimony trioxide, barium acetate and yttrium nitrate (Solution C), when unheated; and FIG. 5(b) represents the same sensor when heated.

A comparison of the performance of the heated sensors represented by FIGS. 3 and 4, with the control sensor represented by FIGS. 2(a) and 2(b) shows that the sensor amplitude has increased to about 0.8V. Moreover, the hysteresis between rich→lean, and lean→rich transitions was reduced to about 0.02λ.

In addition, a comparison of FIGS. 3 and 4 shows that the addition of barium in antimony further reduced the hysteresis between transitions.

FIG. 5(a) shows that the addition of yttrium improved the switching performance of the unheated sensors by further reducing the impedance of the sensing element. Comparatively, the sensor impedance was reduced by 50%.

As compared to untreated sensor represented by FIG. 2(a), the unheated sensor amplitude of the treated sensor represented by FIG. 5(a) was increased by about 0.4V and the hysteresis between rich→lean and lean→rich transitions was reduced by more than 0.03%.

Similarly, a comparison of the treated sensor represented by FIG. 5(b) with the untreated sensor represented by FIG. 2(b) shows that the hysteresis between the transitions was substantially reduced while sensor amplitude was maintained.

### Example 3

a) A calcined oxide mixture was prepared, for use in ink compositions or slurries. A mixture of 0.25 Mole of antimony trioxide (Sb₂O₃); 0.125 Mole of barium acetate (BaC₂H₃O₂); 0.25 Mole of yttrium nitrate (Y₂NO₃); 0.5 Mole potassium carbonate (K₂CO₃); and 0.2 Mole lead nitrate (PbNO₃) was prepared. The mixture of oxides was heated for about 2 hours at about 800° C. to calcine the oxides. The calcined oxide mixture was then ball milled for about 24 hours, seived, and stored.

b) an electrode ink composition was prepared using the foregoing calcined oxide mixture, for printing electrodes. The calcined oxide mixture, a platinum powder and zirconia powder were dispersed in diluent oil. The resulting composition was a paste containing about 58 wt. % platinum, about 3.5 wt. % zirconia, about 3.5 wt. % of the calcined oxide mixture, and had a solids content of about 65 wt. %. The electrode ink composition was used to print the electrodes on a green partially stablized zirconia electrolyte tape.

c) A fugitive ink composition was prepared using the foregoing calcined inorganic oxide mixture, for printing air channels. The calcined oxide mixture, and a fugitive material were dispersed in a diluent oil. The resulting composition was a paste containing, about 3.5 wt. % of the calcined oxide mixture, about 35 wt. % fugitive material, and having a solids content of about 3.5 wt. %. The fugitive ink composition was used to print an air channel on a green alumina support tape.

d) A porous protective green tape was prepared using the foregoing calcined inorganic oxide. The calcined oxide mixture about 2.5 wt. % from (a) was dispersed in a ceramic slurry consisting of about 22 wt. % alumina, 26 wt % zirconia, 6.8 wt. % carbon, 10.4 wt. % organic binder, and 34.8 wt. % solvent (a mixture of 1.4 parts methyl ethyl ketone to 1 part ethanol). The slurry was then tape casted to form the porous protective green tape for subsequent lamination to form the sensor.

e) A sensing element was formed using the foregoing electrodes, air channel and porous protection green tapes incorporating the calcined inorganic oxide mixture. The sensing element was laminated by pressurizing and heating to form a green sensing element, and then heated to a temperature of about 1,500° C. to calcine and react the inorganic oxides and sinter the supports and electrolytes. The sensing elements were then assembled in a package for testing.

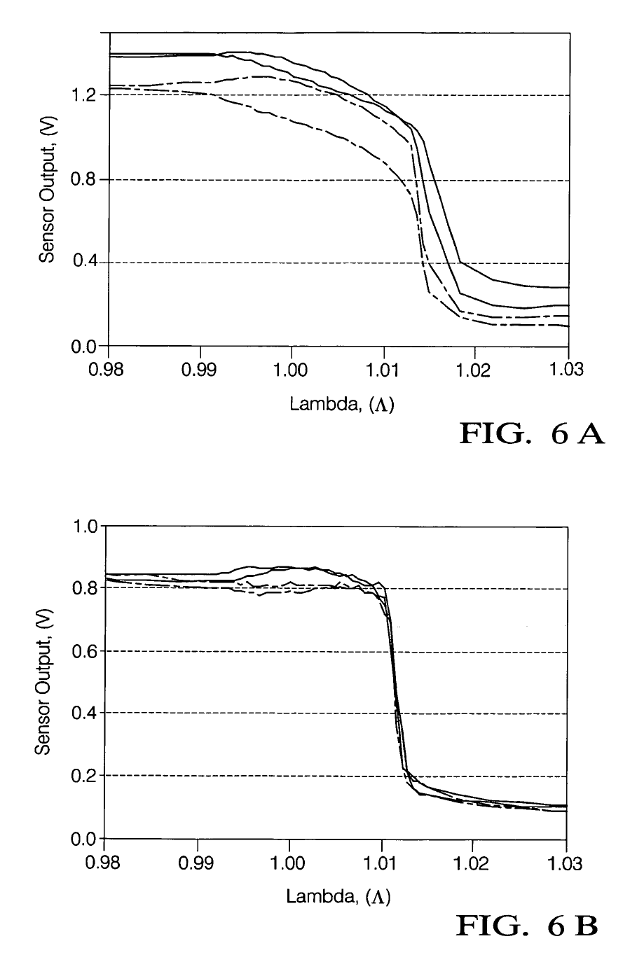

A graphical representation of the switching characteristics of the foregoing sensing elements is shown in FIGS. 6(a) and 6(b). FIG. 6(a) represents the sensors when unheated; FIG. 6(b) represents the sensors when heated.

A comparison of the performance of the unheated sensor represented by FIG. 6(a) with the unheated control sensor represented by FIG. 3(a) shows that the sensor amplitude increased by about 0.8V. Moreover, there was a reduction of more than 0.03λ in the hysteresis between rich→lean and lean→rich transitions.

Similarly, a comparison of the performance of the heated sensor represented by FIG. 6(b), with the heated control sensor represented by FIG. 3(b) shows that the hysteresis between the transitions was substantially reduced while the sensor amplitude was maintained.

### Example 4

Air channels were formed on two (2) green sheets of alumina using the fugitive ink composition from Example 3. Two green sensing elements were formed standard raw materials and the alumina green sheets printed with the air channels. About 100 milligrams of Sb/Ba/Y/K/PbOₓ calcined oxide powder were placed in a slotted alumina setter. The green sensing elements were loaded onto the slotted alumina setter such that the side of the electrode that comprised the porous protection layer faced the oxide powder. The green sensing elements were then co-fired to at about 1500° C. to calcine the green sensing elements. During the sintering process, the inorganic oxides were volatilized; the volatilized oxides were then incorporated in the sensor structure including porous layer, electrode, and the electrolyte.

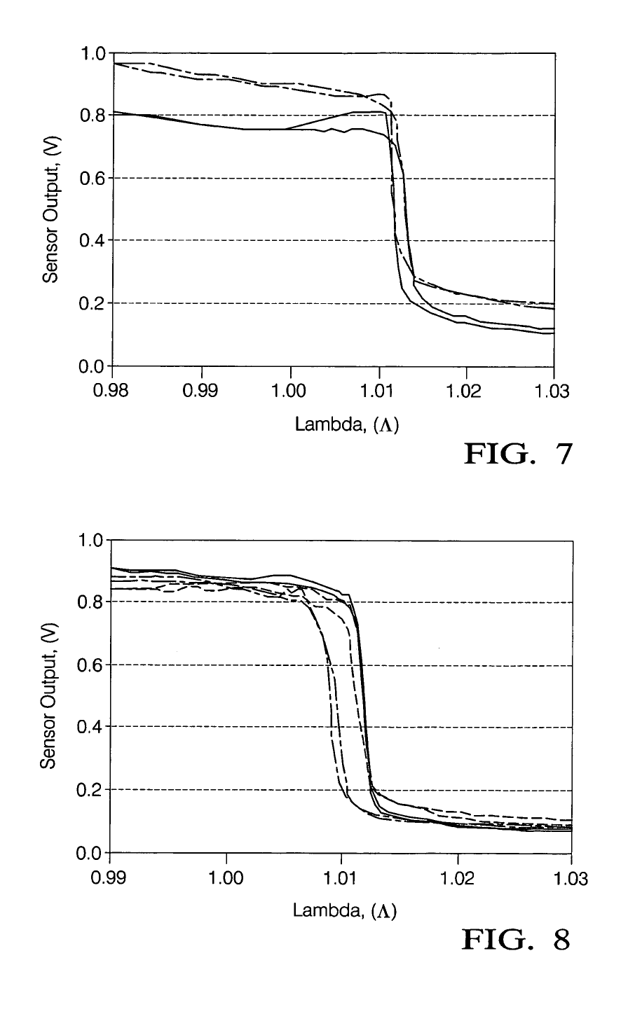

A graphical representation of the switching characteristics of the foregoing heated sensing elements is shown in FIG. 7.

A comparison of treated, heated sensor represented by FIG. 7 with untreated heated control sensor represented by FIG. 2(b) shows that the hysteresis between rich→lean and lean→rich transitions was reduced by about 0.015λ, while the sensor amplitude was maintained.

Reduction in hysteresis, symmetrical transitions, and low temperature switching developments represent significant achievements in enhancing sensor performance with respect to light off time and emission control characteristics.

### Example 5

a) A calcined oxide mixture was prepared, for use in ink compositions or slurries. A mixture of 1.0 Mole of potassium antimonate (KSbO₃); 0.2 Mole of barium acetate (BaC₂H₃O₂); 2.0 Mole of yttrium nitrate (Y₂O₃); and 1.0 Mole potassium carbonate (K₂CO₃) was prepared. The mixture was heated for about 2 hours at about 800° C. to calcine the oxides. The calcined oxide mixture was then ball milled for about 100 hours, seived, and stored.

b) An electrode ink composition was prepared using the foregoing calcined oxide mixture, for printing electrodes. The calcined oxide mixture, a platinum powder and zirconia powder were dispersed in a diluent oil. The resulting composition was a paste containing about 58 wt. % platinum, about 3.5 wt. % zirconia, about 3.5 wt. % of the calcined oxide mixture, and had a solids content of about 65 wt. %. The electrode ink composition was used to print the electrodes on a green partially stablized zirconia electrolyte tape.

c) A fugitive ink composition was prepared using the foregoing calcined inorganic oxide mixture, for printing air channels. The calcined oxide mixture, and a fugitive material were dispersed in a diluent oil. The resulting composition was a paste containing, about 4 wt. % of the calcined oxide mixture, about 35 wt. % carbon a fugitive material, and having a solids content of about 4 wt. %. The fugitive ink composition was used to print an air channel on a green alumina support tape.

d) A sensing element was formed using the foregoing printed electrodes and air channel incorporating the calcined inorganic oxide mixture. The sensing element was laminated by pressurizing and heating to form a green sensing element, and then heated to a temperature of about 1,500° C. to calcine the inorganic oxides and sinter the supports and electrolytes. The sensing elements were then assembled in a package for testing.

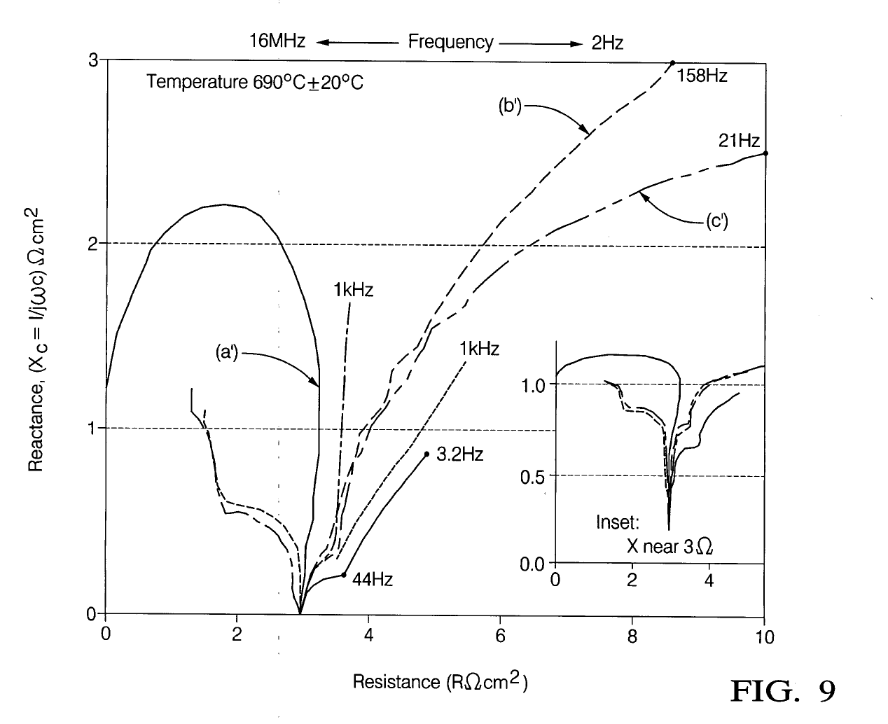

FIG. 8 is a graphical representation of the switching characteristics of three (3) sensing elements, when heated. FIG. 9 is a graphical representation of the resistance of impedance spectra of the same sensing elements. The sensing elements represented on the graphs of FIGS. 8 and 9 are: (a) the instant sensing element; (b) the sensing element of Example 3, which contained lead; and (c) the EHF conditioned control sensor.

FIG. 8 shows that the instant mixed oxide recipe has superior switching characteristics in reducing lean shift (0.0025λ) while maintaining the sensor amplitude, in comparison to the sensor of Example 3 (which contained lead) and the EHF conditioned control sensor. Further, the absence of lead oxide in the instant sensor avoids environmental and hazardous material issues.

FIG. 9 shows that the instant sensors also have an order of magnitude lower resistive components than the sensor of Example 3 (which contained lead) and the control sensor (EHF conditioned). The high frequency looping shown with reference to (a) is a measurement artifact resulting from the inductance of the electrode leads, very low capacitance, and the resistance of the sensor. FIG. 9 shows that the instant oxygen sensor inks reduce the impedance significantly, and allow the electrolyte lattice to transfer oxygen ions more effectively.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A sensing element comprising:
an electrochemical cell;
wherein the sensing element comprises a calcined inorganic oxide selected from an alkali metal oxide; a trivalent metal oxide; a multivalent metal oxide; and combinations comprising at least one of the foregoing.

2. The sensing element of claim 1, wherein the alkali metal oxide comprises an oxide of barium, potassium, lithium, sodium, rubineum, cesium, magnesium, calcium, strontium, and combinations comprising at least one of the foregoing.

3. The sensing element of claim 1, wherein the multivalent metal oxide comprises an oxide of yttrium, scandium, samarium, gadolinium, ytterbium, and compositions comprising at least one of the foregoing.

4. The sensing element of claim 1, wherein the calcined inorganic oxdide comprises an antimony oxide.

5. The sensing element of claim 1, wherein the calcined inorganic oxdide comprises an alkali metal.

6. The sensing element of claim 1, wherein the inorganic oxide is free of lead.

7. The sensing element of claim 1, wherein the sensing element comprises a planar sensor.

8. The sensing element of claim 1, wherein the sensing element comprises an oxygen sensor.

9. A method of forming a sensing element, comprising:
forming a calcined inorganic oxide precursor;
applying the precursor to the sensing element; and
heating the sensing element;
wherein the inorganic oxide is selected from the group consisting of an alkali metal oxide; a trivalent metal oxide; a multivalent metal oxide; and combinations comprising at least one of the foregoing.

10. The method of claim 9, comprising calcining the inorganic oxide before applying the precursor.

11. The method of claim 9, comprising calcining the inorganic oxide while heating the sensing element.

12. The method of claim 9, wherein the alkali metal oxide comprises an oxide of barium, potassium, lithium, sodium, rubineum, cesium, magnesium, calcium, strontium, and combinations comprising at least one of the foregoing.

13. The method of claim 9, wherein the multivalent metal oxide comprises an oxide of yttrium, scandium, samarium, gadolinium, ytterbium, and compositions comprising at least one of the foregoing.

14. The method of claim 9, wherein the calcined inorganic oxide comprises an antimony oxide.

15. The method of claim 9, wherein the calcined inorganic oxide comprises an alkali metal.

16. The method of claim 9, wherein the calcined inorganic oxide is free of lead.

17. The method of claim 9, comprising forming a vapor of the calcined inorganic oxide and exposing the sensing element to the vapor during the heating.

18. The method of claim 9, wherein the sensing element comprises a planar sensor.

19. The method of claim 9, wherein the sensing element comprises an oxygen sensor.

20. A sensing element precursor comprising an inorganic oxide selected from the group consisting of an alkali metal oxide; a trivalent metal oxide; a multivalent metal oxide; and combinations comprising at least one of the foregoing.

21. The sensing element precursor of claim 20, comprising a calcined inorganic oxide.
